(19) United States
(12) Patent Application Publication
(10) Pub. No.: US 2026/0163918 A1
(43) Pub. Date: Jun. 11, 2026

(54) Systems and methods for generating an object for a network policy

(71) Applicant: Sophos Limited, Abingdon (GB)

(72) Inventors: Prashant Gaur, Bangalore (IN); Ashish Aswal, Rishikesh (IN); Laxmikant Agarwal, Bangalore (IN); Chandan Kumar Ghosh, West Bengal (IN)

(21) Appl. No.: 18/977,305

(22) Filed: Dec. 11, 2024

(51) Int. Cl. H04L 9/40

(52) U.S. Cl. CPC H04L 63/20

(57) ABSTRACT

Systems and methods for generating at least one object for a network policy. The method includes receiving at an interface a first object including a first plurality of data entries of a first type; storing the first object in a cloud accessible storage location for subsequent access; receiving at the interface a second object including a second plurality of data entries of the first type; storing the second object in the cloud accessible storage location for subsequent access; receiving a request to enforce a network policy that uses the first object; determining, using one or more processors executing instructions stored on memory, that the first object references the second object; and enforcing, using the one or more processors, the network policy using the first object and second object.

### TECHNICAL FIELD

The present application relates generally to systems and methods for managing a network and, more particularly but not exclusively, to systems and methods for generating a network policy.

### BACKGROUND

Secure Access Service Edge (SASE) is a cloud computing service to provide security controls at network endpoints or otherwise at edge computing locations. An administrator may use SASE to enforce a particular security policy on their network. This may require the administrator to create multiple rules for each individual device, network, subnet, or the like.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

Embodiments herein provide systems and methods for generating one or more objects for one or more network policies or rules A network administrator or other personnel (for simplicity, “administrator”) may define or receive a first object. An object is a set of similar types of data or configurations. Defining objects allows an administrator to group data in a logical manner, and removes the need to define duplicate configurations across multiple network policies.

The systems and methods described herein may receive a request to enforce a network policy that uses the first object. For example, the first object may refer to a set of internet protocol (IP) addresses, and using this object, a network policy can be defined to block the IP addresses from accessing a certain website. The embodiments herein may determine that the first object references a second object that includes data with the same type of the data of the first object (i.e., IP addresses). Because the first object references the second object, the embodiments herein may then enforce the network policy using the first object and the second object.

### BRIEF DESCRIPTION OF DRAWINGS

Non-limiting and non-exhaustive embodiments of the invention are described with reference to the following figures, wherein like reference numerals refer to like parts throughout the various views unless otherwise specified:

FIG. 1 illustrates a block diagram of a threat management system in accordance with one embodiment;

FIG. 2 illustrates a system for generating an object for a network policy in accordance with one embodiment;

FIG. 3 illustrates the object service of FIG. 2 in accordance with one embodiment;

FIG. 4 depicts a sequence diagram for performing a validation procedure in accordance with one embodiment;

FIG. 5 illustrates a diagram of an object in accordance with one embodiment;

FIG. 6 depicts a sequence diagram for editing an object in accordance with one embodiment; and

FIG. 7 depicts a sequence diagram of an internal flow for enforcing an object in accordance with one embodiment.

### DETAILED DESCRIPTION

Various embodiments are described more fully below with reference to the accompanying drawings, which form a part hereof, and which show specific embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

In accordance with the described embodiments, an object service and a rules service execute in a control plane to define SASE polices. A data plane ultimately enforces these policies. Specifically, the object service creates and maintains objects, and the rules service consumes these objects to define the rules or policies to be enforced. In addition to enabling an administrator to create objects, the embodiments herein also allow an administrator to view, update, and delete objects.

An object may comprise a set of various types of data. As discussed previously, anetwork type of object may be a collection of IP addresses or ranges of IP addresses. For example, an administrator of an enterprise network with multiple physical locations may use distinct sets of IP subnets at each location. In accordance with the embodiments herein, the administrator can create objects for each physical location, wherein the objects contain the set of IP addresses or subnets that are relevant to a particular location. An administrator may nest similar kinds of objects together, such as by having a first object reference a second object. This creates an object configuration that combines or otherwise nests multiple objects for multiple locations together.

The embodiments herein may support a variety of object types. A “network object” may include data such as IP addresses, IP address range, or an IP subnet. A “domain” or “URL” object may include data such as subdomain(s). A “GeoIP” object may include data such as countries or continents. Other types of objects may include data such as network services, web categories, or the like. These are only examples, and other types of objects in addition to or in lieu of those mentioned above may be used in conjunction with the described embodiments.

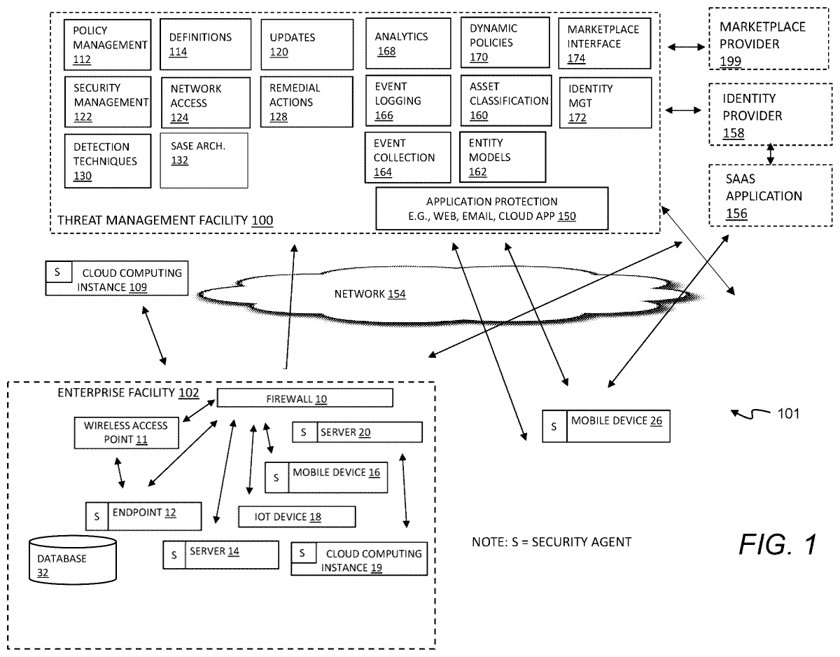

FIG. 1 illustrates a block diagram of a threat management system 101 providing protection against a plurality of threats, such as malware, viruses, spyware, cryptoware, adware, Trojans, spam, intrusion, policy abuse, improper configuration, vulnerabilities, improper access, uncontrolled access, and more. A threat management facility 100 may communicate with, coordinate, and control operation of security functionality at different control points, layers, and levels within the threat management system 101. A number of capabilities may be provided by a threat management facility 100, with an overall goal to intelligently use the breadth and depth of information that is available about the operation and activity of compute instances and networks as well as a variety of available controls. Another overall goal is to provide protection needed by an organization that is dynamic and able to adapt to changes in compute instances and new threats. In embodiments, the threat management facility 100 may provide protection from a variety of threats to a variety of compute instances in a variety of locations and network configurations.

As one example, users of the threat management facility 100 may define and enforce policies that control access to and use of compute instances, networks and data. Administrators may update policies such as by designating authorized users and conditions for use and access. The threat management facility 100 may update and enforce those policies at various levels of control that are available, such as by directing compute instances to control the network traffic that is allowed to traverse firewalls and wireless access points, applications and data available from servers, applications and data permitted to be accessed by endpoints, and network resources and data permitted to be run and used by endpoints. The threat management facility 100 may provide many different services, and policy management may be offered as one of the services.

Turning to a description of certain capabilities and components of the threat management system 101, the enterprise facility 102 may be or may include any networked computer-based infrastructure. For example, the enterprise facility 102 may be corporate, commercial, organizational, educational, governmental, or the like. As home networks become more complicated and include more compute instances at home and in the cloud, an enterprise facility 102 may also or instead include a personal network such as a home or a group of homes. The enterprise facility's 102 computer network may be distributed amongst a plurality of physical premises such as buildings on a campus, and located in one or in a plurality of geographical locations. The configuration of the enterprise facility as shown is by way of example, and it will be understood that there may be any number of compute instances, less or more of each type of compute instances, and other types of compute instances. As shown, the enterprise facility includes a firewall 10, a wireless access point 11, an endpoint 12, a server 14, a mobile device 16, an appliance or Internet-of-Things (IOT) device 18, a cloud computing instance 19, a server 20, a user device, an application load balancer 30, and a network load balancer 34. Again, the compute instances 10-20 depicted are by way of example, and there may be any number or types of compute instances 10-20 in a given enterprise facility. For example, in addition to the elements depicted in the enterprise facility 102, there may be one or more gateways, bridges, wired networks, wireless networks, virtual private networks, other compute instances, and so on.

The threat management facility 100 may include or otherwise be in communication certain facilities, such as a policy management facility 112, security management facility 122, update facility 120, definitions facility 114, network access facility 124, remedial action facility 128, detection techniques facility 130, a Secure Access Service Edge (SASE) architecture 132, application protection 150, asset classification facility 160, entity model facility 162, event collection facility 164, event logging facility 166, analytics facility 168, dynamic policies facility 170, identity management facility 172, and marketplace interface facility 174, a firmware repository 176, a build system 178, as well as other facilities. For example, there may be a testing facility, a threat research facility, and other facilities (not shown). It should be understood that the threat management facility 100 may be implemented in whole or in part on a number of different compute instances, with some parts of the threat management facility on different compute instances in different locations. For example, some or all of one or more of the various facilities 100, 112-174 may be provided as part of a security agent S that is included in software running on a compute instance 10-26 within the enterprise facility 102. Some or all of one or more of the facilities 100, 112-174 may be provided on the same physical hardware or logical resource as a gateway, such as a firewall 10, or wireless access point 11. Some or all of one or more of the facilities 100, 112-174 may be provided on one or more cloud servers that are operated by the enterprise or by a security service provider, such as the cloud computing instance 109.

In embodiments, a marketplace provider 199 may make available one or more additional facilities to the enterprise facility 102 via the threat management facility 100. The marketplace provider 199 may communicate with the threat management facility 100 via the marketplace interface facility 174 to provide additional functionality or capabilities to the threat management facility 100 and compute instances 10-26. As non-limiting examples, the marketplace provider 199 may be a third-party information provider, such as a physical security event provider; the marketplace provider 199 may be a system provider, such as a human resources system provider or a fraud detection system provider; the marketplace provider 199 may be a specialized analytics provider; and so on. The marketplace provider 199, with appropriate permissions and authorization, may receive and send events, observations, inferences, controls, convictions, policy violations, or other information to the threat management facility 100. For example, the marketplace provider 199 may subscribe to and receive certain events, and in response, based on the received events and other events available to the marketplace provider 199, send inferences to the marketplace interface facility 174, and in turn to the analytics facility 168, which in turn may be used by the security management facility 122.

The identity provider 158 may be any remote identity management system or the like configured to communicate with an identity management facility 172, e.g., to confirm identity of a user as well as provide or receive other information about users that may be useful to protect against threats. In general, the identity provider 158 may be any system or entity that creates, maintains, and manages identity information for principals while providing authentication services to relying party applications, e.g., within a federation or distributed network. The identity provider 158 may, for example, offer user authentication as a service, where other applications, such as web applications, outsource the user authentication step(s) to a trusted identity provider.

In embodiments, the identity provider 158 may provide user identity information, such as multi-factor authentication, to a software-as-a-service (SaaS) application. Centralized identity providers such as Microsoft Azure, may be used by an enterprise facility instead of maintaining separate identity information for each application or group of applications, and as a centralized point for integrating multifactor authentication. In embodiments, the identity management facility 172 may communicate hygiene, or security risk information, to the identity provider 158. The identity management facility 172 may determine a risk score for a user based on the events, observations, and inferences about that user and the compute instances associated with the user. If a user is perceived as risky, the identity management facility 172 can inform the identity provider 158, and the identity provider 158 may take steps to address the potential risk, such as to confirm the identity of the user, confirm that the user has approved the SaaS application access, remediate the user's system, or such other steps as may be useful.

In embodiments, threat protection provided by the threat management facility 100 may extend beyond the network boundaries of the enterprise facility 102 to include clients (or client facilities) such as an endpoint 22 or other type of computing device outside the enterprise facility 102, a mobile device 26, a cloud computing instance 109, or any other devices, services or the like that use network connectivity not directly associated with or controlled by the enterprise facility 102, such as a mobile network, a public cloud network, or a wireless network at a hotel or coffee shop or other type of public location. While threats may come from a variety of sources, such as from network threats, physical proximity threats, secondary location threats, the compute instances 10-26 may be protected from threats even when a compute instance 10-26 is not connected to the enterprise facility 102 network, such as when compute instances 22 or 26 use a network that is outside of the enterprise facility 102 and separated from the enterprise facility 102, e.g., by a gateway, a public network, and so forth.

In some implementations, compute instances 10-26 may communicate with cloud applications, such as a SaaS application 156. The SaaS application 156 may be an application that is used by but not operated by the enterprise facility 102. Examples of commercially available SaaS applications 156 include Salesforce, Amazon Web Services (AWS) applications, Google Apps applications, Microsoft Office 365 applications and so on. A given SaaS application 156 may communicate with an identity provider 158 to verify user identity consistent with the requirements of the enterprise facility 102. The compute instances 10-26 may communicate with an unprotected server (not shown) such as a web site or a third-party application through an network 154 such as the Internet or any other public network, private network or combination thereof.

In embodiments, aspects of the threat management facility 100 may be provided as a stand-alone solution. In other embodiments, aspects of the threat management facility 100 may be integrated into a third-party product. An application programming interface (e.g., a source code interface) may be provided such that aspects of the threat management facility 100 may be integrated into or used by or with other applications. For instance, the threat management facility 100 may be stand-alone in that it provides direct threat protection to an enterprise or computer resource, where protection is subscribed to the facility 100. Alternatively, the threat management facility 100 may offer protection indirectly, through a third-party product, where an enterprise may subscribe to services through the third-party product, and threat protection to the enterprise may be provided by the threat management facility 100 through the third-party product.

The security management facility 122 may provide protection from a variety of threats by providing, as non-limiting examples, endpoint security and control, email security and control, web security and control, reputation-based filtering, machine learning classification, control of unauthorized users, control of guest and non-compliant computers, and more.

The security management facility 122 may provide malicious code protection to a compute instance. The security management facility 122 may include functionality to scan applications, files, and data for malicious code, remove or quarantine applications and files, prevent certain actions, perform remedial actions, as well as other security measures. Scanning may use any of a variety of techniques, including without limitation signatures, identities, classifiers, and other suitable scanning techniques. In embodiments, the scanning may include scanning some or all files on a periodic basis, scanning an application when the application is executed, scanning data transmitted to or from a device, scanning in response to predetermined actions or combinations of actions, and so forth. The scanning of applications, files, and data may be performed to detect known or unknown malicious code or unwanted applications. Aspects of the malicious code protection may be provided, for example, in a security agent of an endpoint 12, in a wireless access point 11 or firewall 10, as part of application protection 150 provided by the cloud, and so on.

In an embodiment, the security management facility 122 may provide for email security and control, for example to target spam, viruses, spyware and phishing, to control email content, and the like. Email security and control may protect against inbound and outbound threats, protect email infrastructure, prevent data leakage, provide spam filtering, and more. Aspects of the email security and control may be provided, for example, in the security agent of an endpoint 12, in a wireless access point 11 or firewall 10, as part of application protection 150 provided by the cloud, and so on.

In an embodiment, security management facility 122 may provide for web security and control, for example, to detect or block viruses, spyware, malware, or unwanted applications; help control web browsing; and the like, which may provide comprehensive web access control to enable safe and productive web browsing. Web security and control may provide Internet use policies, reporting on suspect compute instances, security and content filtering, active monitoring of network traffic, Uniform Resource Identifier (URI) filtering, and the like. Aspects of the web security and control may be provided, for example, in the security agent of an endpoint 12, in a wireless access point 11 or firewall 10, as part of application protection 150 provided by the cloud, and so on.

In an embodiment, the security management facility 122 may provide for network access control, which generally controls access to and use of network connections. Network control may stop unauthorized, guest, or non-compliant systems from accessing networks, and may control network traffic that is not otherwise controlled at the client level. In addition, network access control may control access to virtual private networks (VPN), where VPNs may, for example, include communications networks tunneled through other networks and establishing logical connections acting as virtual networks. In embodiments, a VPN may be treated in the same manner as a physical network. Aspects of network access control may be provided, for example, in the security agent of an endpoint 12, in a wireless access point 11 or firewall 10, as part of application protection 150 provided by the cloud, e.g., from the threat management facility 100 or other network resource(s).

In an embodiment, the security management facility 122 may provide for host intrusion prevention through behavioral monitoring and/or runtime monitoring, which may guard against unknown threats by analyzing application behavior before or as an application runs. This may include monitoring code behavior, application programming interface calls made to libraries or to the operating system, or otherwise monitoring application activities. Monitored activities may include, for example, reading and writing to memory, reading and writing to disk, network communication, process interaction, and so on. Behavior and runtime monitoring may intervene if code is deemed to be acting in a manner that is suspicious or malicious. Aspects of behavior and runtime monitoring may be provided, for example, in the security agent of an endpoint 12, in a wireless access point 11 or firewall 10, as part of application protection 150 provided by the cloud, and so on.

In an embodiment, the security management facility 122 may provide for reputation filtering, which may target or identify sources of known malware. For instance, reputation filtering may include lists of URIs of known sources of malware or known suspicious IP addresses, code authors, code signers, or domains, that when detected may invoke an action by the threat management facility 100. Based on reputation, potential threat sources may be blocked, quarantined, restricted, monitored, or some combination of these, before an exchange of data can be made. Aspects of reputation filtering may be provided, for example, in the security agent of an endpoint 12, in a wireless access point 11 or firewall 10, as part of application protection 150 provided by the cloud, and so on. In embodiments, some reputation information may be stored on a compute instance 10-26, and other reputation data available through cloud lookups to an application protection lookup database, such as may be provided by application protection 150.

In embodiments, information may be sent from the enterprise facility 102 to a third party, such as a security vendor, or the like, which may lead to improved performance of the threat management facility 100. In general, feedback may be useful for any aspect of threat detection. For example, the types, times, and number of virus interactions that an enterprise facility 102 experiences may provide useful information for the preventions of future virus threats. Feedback may also be associated with behaviors of individuals within the enterprise, such as being associated with most common violations of policy, network access, unauthorized application loading, unauthorized external device use, and the like. In embodiments, feedback may enable the evaluation or profiling of client actions that are violations of policy that may provide a predictive model for the improvement of enterprise policies.

An update facility 120 may provide control over when updates are performed. The updates may be automatically transmitted, manually transmitted, or some combination of these. Updates may include software, definitions, reputations or other code or data that may be useful to the various facilities. For example, the update facility 120 may manage receiving updates from a provider, distribution of updates to enterprise facility 102 networks and compute instances, or the like. In embodiments, updates may be provided to the enterprise facility's 102 network, where one or more compute instances on the enterprise facility's 102 network may distribute updates to other compute instances.

The threat management facility 100 may include a policy management facility 112 that manages rules or policies for the enterprise facility 102. Examples of rules include access permissions associated with networks, applications, compute instances, users, content, data, and the like. The policy management facility 112 may use a database, a text file, other data store, or a combination to store policies. In an embodiment, a policy database may include a block list, a black list, an allowed list, a white list, and more. As a few non-limiting examples, policies may include a list of enterprise facility 102 external network locations/applications that may or may not be accessed by compute instances, a list of types/classifications of network locations or applications that may or may not be accessed by compute instances, and contextual rules to evaluate whether the lists apply. For example, there may be a rule that does not permit access to sporting websites. When a website is requested by the client facility, a security management facility 122 may access the rules within a policy facility to determine if the requested access is related to a sporting website.

The policy management facility 112 may include access rules and policies that are distributed to maintain control of access by the compute instances 10-26 to network resources. These policies may be defined for an enterprise facility, application type, subset of application capabilities, organization hierarchy, compute instance type, user type, network location, time of day, connection type, or any other suitable definition. Policies may be maintained through the threat management facility 100, in association with a third party, or the like. For example, a policy may restrict instant messaging (IM) activity by limiting such activity to support personnel when communicating with customers. More generally, this may allow communication for departments as necessary or helpful for department functions, but may otherwise preserve network bandwidth for other activities by restricting the use of IM to personnel that need access for a specific purpose. In an embodiment, the policy management facility 112 may be a stand-alone application, may be part of the network server facility 142, may be part of the enterprise facility 102 network, may be part of the client facility, or any suitable combination of these.

The policy management facility 112 may include dynamic policies that use contextual or other information to make security decisions. As described herein, the dynamic policies facility 170 may generate policies dynamically based on observations and inferences made by the analytics facility. The dynamic policies generated by the dynamic policy facility 170 may be provided by the policy management facility 112 to the security management facility 122 for enforcement.

In embodiments, the threat management facility 100 may provide configuration management as an aspect of the policy management facility 112, the security management facility 122, or some combination. Configuration management may define acceptable or required configurations for the compute instances 10-26, applications, operating systems, hardware, or other assets, and manage changes to these configurations. Assessment of a configuration may be made against standard configuration policies, detection of configuration changes, remediation of improper configurations, application of new configurations, and so on. An enterprise facility may have a set of standard configuration rules and policies for particular compute instances which may represent a desired state of the compute instance. For example, on a given compute instance 12, 14, 18, a version of a client firewall may be required to be running and installed. If the required version is installed but in a disabled state, the policy violation may prevent access to data or network resources. A remediation may be to enable the firewall. In another example, a configuration policy may disallow the use of Universal Serial Bus (USB) disks, and the policy management facility 112 may require a configuration that turns off USB drive access via a registry key of a compute instance. Aspects of configuration management may be provided, for example, in the security agent of an endpoint 12, in a wireless access point 11 or firewall 10, as part of application protection 150 provided by the cloud, or any combination of these.

In embodiments, the threat management facility 100 may also provide for the isolation or removal of certain applications that are not desired or may interfere with the operation of a compute instance 10-26 or the threat management facility 100, even if such application is not malware per se. The operation of such products may be considered a configuration violation. The removal of such products may be initiated automatically whenever such products are detected, or access.

The policy management facility 112 may also require update management (e.g., as provided by the update facility 120). Update management for the security management facility 122 and policy management facility 112 may be provided directly by the threat management facility 100, or, for example, by a hosted system. In embodiments, the threat management facility 100 may also provide for patch management, where a patch may be an update to an operating system, an application, a system tool, or the like, where one of the reasons for the patch is to reduce vulnerability to threats.

In embodiments, the security management facility 122 and policy management facility 112 may push information to the enterprise facility 102 network and/or the compute instances 10-26, the enterprise facility 102 network and/or compute instances 10-26 may pull information from the security management facility 122 and policy management facility 112, or there may be a combination of pushing and pulling of information. For example, the enterprise facility 102 network and/or compute instances 10-26 may pull update information from the security management facility 122 and policy management facility 112 via the update facility 120, an update request may be based on a time period, by a certain time, by a date, on demand, or the like. In another example, the security management facility 122 and policy management facility 112 may push the information to the enterprise facility's 102 network and/or compute instances 10-26 by providing notification that there are updates available for download and/or transmitting the information. In an embodiment, the policy management facility 112 and the security management facility 122 may work in concert with the update facility 120 to provide information to the enterprise facility's 102 network and/or compute instances 10-26. In various embodiments, policy updates, security updates and other updates may be provided by the same or different modules, which may be the same or separate from a security agent running on one of the compute instances 10-26.

As threats are identified and characterized, the definition facility 114 of the threat management facility 100 may manage definitions used to detect and remediate threats. For example, identity definitions may be used for scanning files, applications, data streams, etc. for the determination of malicious code. Identity definitions may include instructions and data that can be parsed and acted upon for recognizing features of known or potentially malicious code. Definitions also may include, for example, code or data to be used in a classifier, such as a neural network or other classifier that may be trained using machine learning. Updated code or data may be used by the classifier to classify threats. In embodiments, the threat management facility 100 and the compute instances 10-26 may be provided with new definitions periodically to include most recent threats. Updating of definitions may be managed by the update facility 120, and may be performed upon request from one of the compute instances 10-26, upon a push, or some combination. Updates may be performed upon a time period, on demand from a device 10-26, upon determination of an important new definition or a number of definitions, and so on.

A threat research facility (not shown) may provide a continuously ongoing effort to maintain the threat protection capabilities of the threat management facility 100 in light of continuous generation of new or evolved forms of malware. Threat research may be provided by researchers and analysts working on known threats, in the form of policies, definitions, remedial actions, and so on.

The security management facility 122 may scan an outgoing file and verify that the outgoing file is permitted to be transmitted according to policies. By checking outgoing files, the security management facility 122 may be able discover threats that were not detected on one of the compute instances 10-26, or policy violation, such transmittal of information that should not be communicated unencrypted.

The threat management facility 100 may control access to the enterprise facility 102 networks. A network access facility 124 may restrict access to certain applications, networks, files, printers, servers, databases, and so on. In addition, the network access facility 124 may restrict user access under certain conditions, such as the user's location, usage history, need to know, job position, connection type, time of day, method of authentication, client-system configuration, or the like. Network access policies may be provided by the policy management facility 112, and may be developed by the enterprise facility 102, or pre-packaged by a supplier. Network access facility 124 may determine if a given compute instance 10-22 should be granted access to a requested network location, e.g., inside or outside of the enterprise facility 102. Network access facility 124 may determine if a compute instance 22, 26 such as a device outside the enterprise facility 102 may access the enterprise facility 102. For example, in some cases, the policies may require that when certain policy violations are detected, certain network access is denied. The network access facility 124 may communicate remedial actions that are necessary or helpful to bring a device back into compliance with policy as described below with respect to the remedial action facility 128. Aspects of the network access facility 124 may be provided, for example, in the security agent of the endpoint 12, in a wireless access point 11, in a firewall 10, as part of application protection 150 provided by the cloud, and so on.

In an embodiment, the network access facility 124 may have access to policies that include one or more of a block list, a black list, an allowed list, a white list, an unacceptable network site database, an acceptable network site database, a network site reputation database, or the like of network access locations that may or may not be accessed by the client facility. Additionally, the network access facility 124 may use rule evaluation to parse network access requests and apply policies. The network access facility 124 may have a generic set of policies for all compute instances, such as denying access to certain types of websites, controlling instant messenger accesses, or the like. Rule evaluation may include regular expression rule evaluation, or other rule evaluation method(s) for interpreting the network access request and comparing the interpretation to established rules for network access. Classifiers may be used, such as neural network classifiers or other classifiers that may be trained by machine learning.

The threat management facility 100 may include an asset classification facility 160. The asset classification facility will discover the assets present in the enterprise facility 102. A compute instance such as any of the compute instances 10-26 described herein may be characterized as a stack of assets. The one level asset is an item of physical hardware. The compute instance may be, or may be implemented on physical hardware, and may have or may not have a hypervisor, or may be an asset managed by a hypervisor. The compute instance may have an operating system (e.g., Windows, macOS, OS X, Linux, Android, iOS). The compute instance may have one or more layers of containers. The compute instance may have one or more applications, which may be native applications, e.g., for a physical asset or virtual machine, or running in containers within a computing environment on a physical asset or virtual machine, and those applications may link libraries or other code or the like, e.g., for a user interface, cryptography, communications, device drivers, mathematical or analytical functions and so forth. The stack may also interact with data. The stack may also or instead interact with users, and so users may be considered assets.

The threat management facility 100 may include the entity model facility 162. The entity models may be used, for example, to determine the events that are generated by assets. For example, some operating systems may provide useful information for detecting or identifying events. For examples, operating systems may provide process and usage information that accessed through an application programming interface (API). As another example, it may be possible to instrument certain containers to monitor the activity of applications running on them. As another example, entity models for users may define roles, groups, permitted activities and other attributes.

The event collection facility 164 may be used to collect events from any of a wide variety of sensors that may provide relevant events from an asset, such as sensors on any of the compute instances 10-26, the application protection 150, a cloud computing instance 109 and so on. The events that may be collected may be determined by the entity models. There may be a variety of events collected. Events may include, for example, events generated by the enterprise facility 102 or the compute instances 10-26, such as by monitoring streaming data through a gateway such as firewall 10 and wireless access point 11, monitoring activity of compute instances, monitoring stored files/data on the compute instances 10-26 such as desktop computers, laptop computers, other mobile computing devices, and cloud computing instances 19, 109. Events may range in granularity. One example of an event is the communication of a specific packet over the network. Another example of an event may be identification of an application that is communicating over a network.

The event logging facility 166 may be used to store events collected by the event collection facility 164. The event logging facility 166 may store collected events so that they can be accessed and analyzed by the analytics facility 168. Some events may be collected locally, and some events may be communicated to an event store in a central location or cloud facility. Events may be logged in any suitable format.

Events collected by the event logging facility 166 may be used by the analytics facility 168 to make inferences and observations about the events. These observations and inferences may be used as part of policies enforced by the security management facility Observations or inferences about events may also be logged by the event logging facility 166.

When a threat or other policy violation is detected by the security management facility 122, the remedial action facility 128 may remediate the threat. Remedial action may take a variety of forms, non-limiting examples including collecting additional data about the threat, terminating or modifying an ongoing process or interaction, sending a warning to a user or administrator, downloading a data file with commands, definitions, instructions, or the like to remediate the threat, requesting additional information from the requesting device, such as the application that initiated the activity of interest, executing a program or application to remediate against a threat or violation, increasing telemetry or recording interactions for subsequent evaluation, (continuing to) block requests to a particular network location or locations, scanning a requesting application or device, quarantine of a requesting application or the device, isolation of the requesting application or the device, deployment of a sandbox, blocking access to resources, e.g., a USB port, or other remedial actions. More generally, the remedial action facility 128 may take any steps or deploy any measures suitable for addressing a detection of a threat, potential threat, policy violation or other event, code or activity that might compromise security of a computing instance 10-26 or the enterprise facility 102.

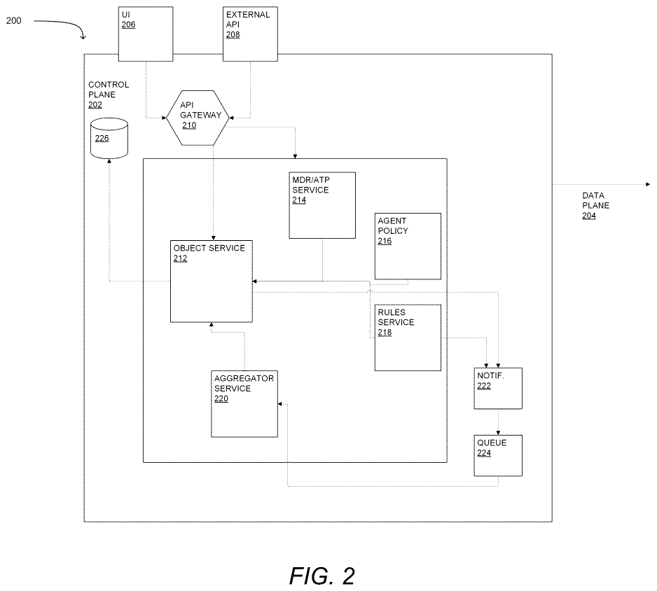

FIG. 2 illustrates a system 200 for generating an object for a network policy in accordance with one embodiment. The system 200 may execute on a control plane 202 that is associated with a particular region and in communication with a data plane 204. These control plane 202 and the data plane 204 may be part of the SASE architecture 132 of FIG. 1, for example. In operation an administrator may access a user interface (UI) 206 or an external application programming interface (API) 208. For example, a user may be an enterprise network administrator tasked with generating one or more network policies.

The UI 206 or the external API 208 may communicate data such as instructions to an API gateway 210. In some embodiments, the API gateway 210 may be an APIGEE® API Gateway offered by Amazon. com, Inc., headquartered in Seattle, Washington. However, other services whether available now or invented hereafter may be implemented as long as the features of the various embodiments described herein may be accomplished.

The API gateway 210 may forward data to an object service 212 executing in the control plane 202. The object service 212 may be in further communication with a Managed Detection and Response/Advanced Threat Protection (MDR/ATP) service 214, an agent policy module 216, a rules service 218, and an aggregator service 220. The MDR/ATP service 214 is a Security Service Edge (SSE) service that creates internal objects for default policies. The agent policy module 216 is an SSE service that creates and references objects from the object service 212.

The rules service 218 is an SSE service that manages policies and rules. Specifically, the rules service 212 consumes objects from the object service 212 to define a policy's match criteria against input traffic. That is, input traffic will be evaluated against a policy. For example, if input traffic originates from a particular country, and there is a policy in place to block input traffic originating from that particular country, the traffic will be blocked.

The aggregator service 220 is an SSE service that compiles policy bundles. Specifically, the policy aggregator service 220 compiles policy bundles based on serialized rules and object contents that are obtained from the rules service 218 and the object service 212, respectively.

The object service 212 may be tasked with creating and maintaining the lifecycle of objects. Creating objects may be beneficial for network administrators or other personnel to group together similar types of configuration data and in a logical manner. Additionally, an administrator may reference or otherwise reuse these objects for multiple policies. This allows administrators to optimize policy configurations without needing to duplicate common configurations across multiple policies.

The control plane 204 may also include a notification service 222 and a queue service 224. The notification service 222 may be implemented as the Amazon Simple Notification Service® (SNS) and the queue service 224 may be implemented as the Amazon Simple Queue Service® (SQS), both offered by AMAZON.COM, INC. of Seattle, Washington. The notification service 222 may provide notifications when an object is created, updated, or deleted, and the queue service 224 may queue said notifications before they are communicated to the aggregator service 220.

Additionally, the embodiments herein may include or rely on one or more cloud-accessible storages such as databases 226 that include data structures such as tables or lists representing these objects. The embodiments herein may leverage these object data structures in matching policy criteria against inputted data. The database(s) 226 may also store data regarding the objects, such as how they are nested with one or more other objects of the same type.

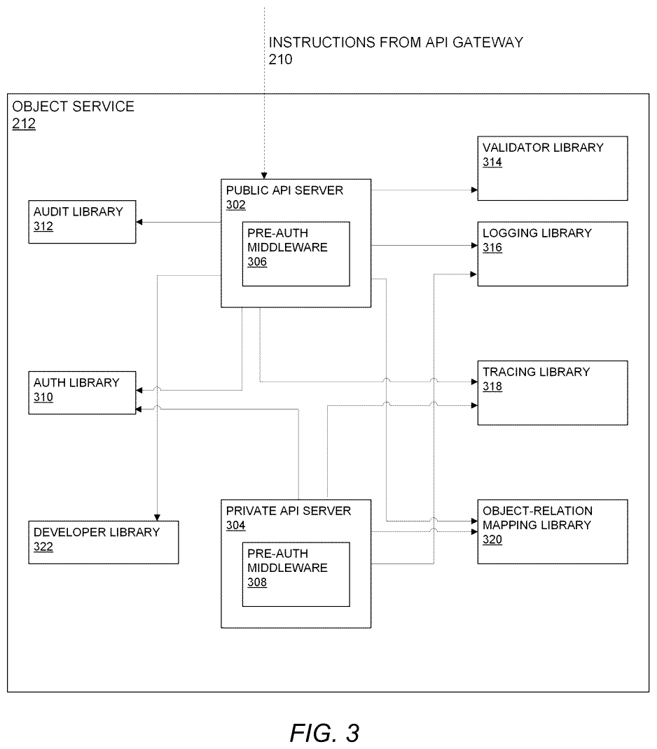

FIG. 3 illustrates the object service 212 of FIG. 2 in accordance with one embodiment. The object service 212 may include a public representational state transfer (REST) API server 302 (for simplicity, “public API 302”), a private REST API server 304 (for simplicity, “private API 304”), and pre-authorization middleware 306, 308 associated with the public API 302 and private API 304, respectively. The object service 212 may further include an authorization library 310, audit library 312, validator library 314, logging library 316, tracing library 318, object-relation mapping library 320, and developer library 322.

In operation, the public API 302 may receive instructions or data from the API gateway 210 of FIG. 2. These instructions may relate to the creation of an object, the updating or editing of an object, the deletion of an object, retrieval of an object, or the like.

An administrator may create an object and assign a name, description, and multiple entries of the object. The embodiments herein may subsequently use objects of the same type in one or more policies. In the context of the present application, a “parent object” may refer to an object that includes one or more nested objects. A “child object” may refer to an object that is referenced by or otherwise nested in a parent object. In some embodiments, there may be up to 50 objects nested in a parent object, with a child object having less than ten levels of nested objects. In some embodiments, there may be no limits on the number of objects nested in a parent object. In some emboidments, any limits may be based only on computing restraints.

An administrator may want to edit or update an object after the object is created. For example, an administrator may want to edit an existing object by editing its various field values. In some embodiments, an administrator may edit an object by nesting or de-nesting objects of the same object type. In some embodiments, an administrator may delete one or more items of an object, such as if the item(s) is no longer associated with the object. The embodiments herein may also allow an administrator to update an object in a way that prevents the administrator from inadvertently nesting an object, such as by not displaying an object that references the object being edited.

Regarding listing of objects, an administrator may want to view an object, such as to determine its content, whether it references other objects, whether it is referenced by other objects, etc. In some embodiments, an administrator may view a list of all existing objects. For a particular object, an administrator may want to view the name of the object, the number of items in the object, the content type, and any type of configuration data such as if or how the object is nested.

Referring back to FIG. 3, the pre-authorization middleware 306 and 308 may perform any required authorization procedures before or during object configuration. The private API 304 may interact with service-to-service APIs to reference objects. Additionally the private API server 304 may be in communication with the rules service 218 and aggregator service 220 of FIG. 2, and may provide them with serialized object contents.

The public API 302 may be in communication with the validator library 314 for performing any appropriate request payload validation. For example, the described embodiments may perform a syntactical validation procedure and a semantical validation procedure on received data such as object configuration requests. In some embodiments, the validator library 314 may use the YANG modeling software.

The authorization library 310 may authorize requests from the API gateway 210. Specifically, the public API 302 and the private API 304 may each use the authorization library 310 to provide authorization for generating or otherwise configuring network policies. For example, in some embodiments, the servers 302 and 304 may use the authorization library 310 for SSAv2 token-based authorization to allow an administrator to manage objects.

The audit library 312 may communicate any actions performed by the administrator to the database 226 or the event collection facility 164 of FIG. 1. These actions may include, but are not limited to create, read, update, and delete (“CRUD”) operations.

Similarly, the logging library 316 may log all transactions and communications generated by the object service 212. The logging library 316 may be in further communication with a viewing tool (not shown in FIG. 3) to allow an interested party to view and troubleshoot error logs.

The tracing library 318 may be a third party-provided library that is tasked with tracing data transactions between services. In some embodiments, the tracing library 318 may be an Open Telemetry software development kit (SDK). The tracing library 318 may be in further communication with any suitable software-as-a-service (SaaS) logging platform. The tracing library 318 may communicate for storage telemetry data such as CPU usage, memory usage, network traffic sent, network traffic received, etc.

The public API 302 and private API 304 may leverage the developer library 322 for generating notification events pertaining to objects. The developer library 322 may be in communication with the notification and queue services 222, 224, respectively, of FIG. 2.

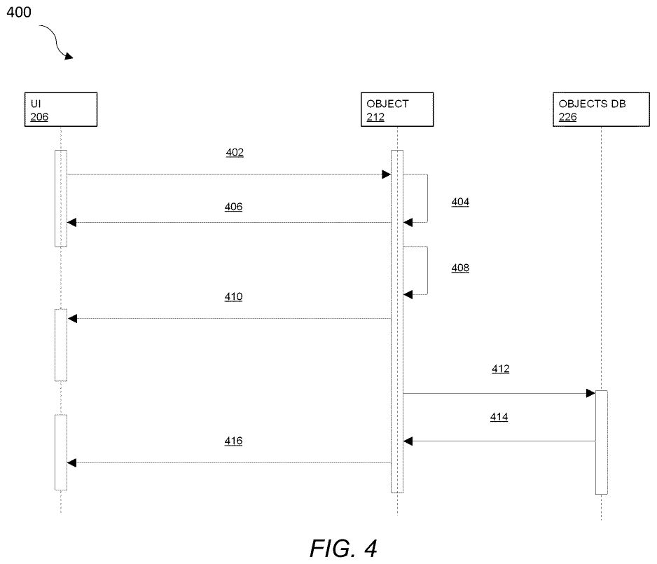

FIG. 4 depicts a sequence diagram 400 for performing a validation procedure in accordance with one embodiment. The UI 206 may communicate 402 request to the object service 212 to create (or update) an object. The object service 212 may perform 404 a validation step to validate the request, such as to determine the request satisfies any thresholds or rules, such as a maximum attribute values limit. In some embodiments, the validator library 314 validation model may perform this step by counting the number of attributes in a proposed object. If the object service 212 determines that the number of attributes does not satisfy the values limit, the object service 212 may communicate 406 to the UI that the request failed.

If the object service 212 determines that the number of attributes satisfies the values limit, the object service 212 may then perform 408 a validation step to determine whether the object satisfies any nesting limits. For example, in some embodiments, an object may not have more than fifty (50) nested objects.

If the object service 212 determines that the request does not satisfy any applicable nesting limits, the object service 212 may communicate 410 a message indicating why the request is denied. If the object service 212 determines the request satisfies any applicable value limits, the object service 212 may then create 412 and store a record in the objects database 226. The objects database 226 may acknowledge 414 the storage of the record with a message 416 to the object service 212. The objects service may then forward a message to the UI 206 to inform the administrator that the object has been stored.

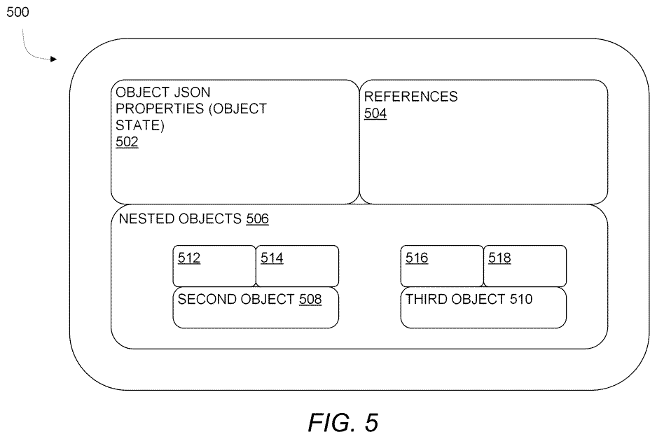

FIG. 5 illustrates a diagram of a first object 500 in accordance with one embodiment. The first object 500 may include object properties 502, references 504, and have one or more nested objects 506. In this configuration, the first object 500 has a nested second object 508 and third object 510. The second object 508 also has associated object properties 512 and references 514. The third object 510 also has associated object properties 516 and references 518.

The object properties 502 may refer to the data values that are associated with the object 500. For example, the object properties 502 may include a set of IP addresses, IP address ranges, geographic locations, or other types of data such as those discussed previously.

The references 504 may refer to a list, table, or other type of data structure that stores data regarding how the first object 500 is used. For example, the references 504 may store data regarding usage of the object 500 in other entities such as policies or rules.

The second object 508 may be configured similarly to the first object 500 in that it has associated properties 512 and references 514. In the case of FIG. 5, the second object 508 and the third object 510 are nested in the first object 500.

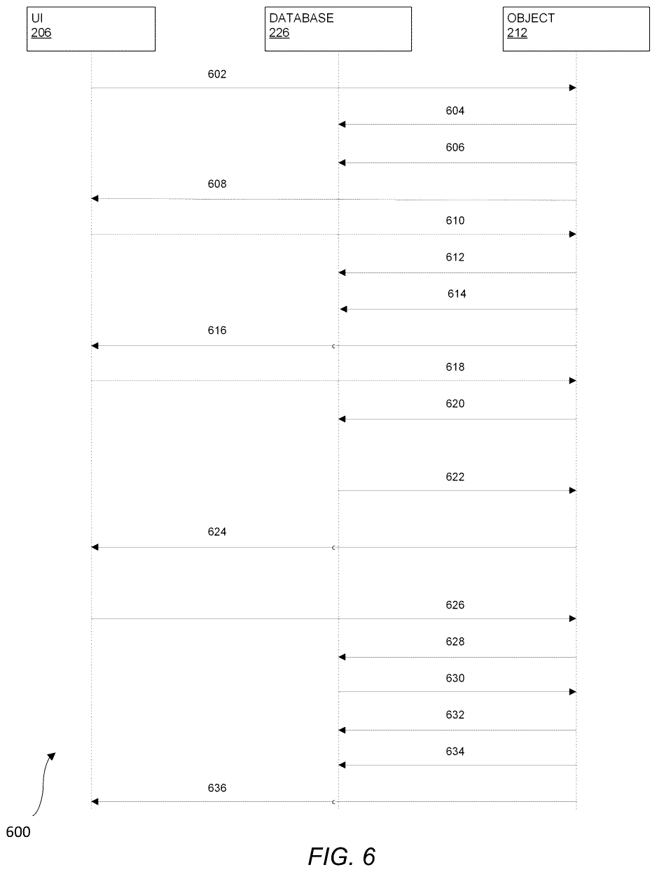

FIG. 6 depicts a sequence diagram 600 for editing an object in accordance with one embodiment. A user may provide an instruction via the UI 206 to create 602 a first object. The instruction may also include an instruction to use a second and third object as nested objects. The request may be communicated to the object service 212.

The object service 212 may respond 604 by storing the object in the database 226. Simultaneously or some time afterward, the object service 212 may update 606 in the database 226 a reference mapping such that the first object references the second object and the first object references the third object. The object service 212 may also communicate 608 a message to the UI 206 to inform the user that the object has been created.

As discussed previously, oftentimes an administrator may need to update an object. For example, the administrator may need to remove a nested object from the object configuration, such that the parent object does not reference the previously-nested object. FIG. 6 also shows a request 610 to remove the nested third object from the first object.

The object service 212 may remove the third object from the first object, and store 612 the first object in the database 226. The object service 212 may also update 614 the reference mapping to remove the reference of the third object from the first object. Finally, the object service 212 may communicate 616 a message to the UI 206 to inform the user that the object has been updated.

As discussed previously, oftentimes an administrator may need to delete a nested object from an object. FIG. 6 also shows a request 618 to delete the second object from the first object. In response, the object service 212 first checks 620 if the second object is referenced in other objects. In this case, a returned value may indicate 622 that the second object is referenced by the first object.

Because the first object references the second object, the object service 212 is unable to delete the second object. Accordingly, the object service 212 communicates 624 a message to the UI 206 informing the user that the request to delete the second object is not allowed.

The user may then communicate 626 a request to the object service 212 to delete the first object. In response, the object service 212 first checks 628 if the first object is referenced in other objects. For example, the object service 212 may reference the database 226. In this case, a returned value may indicate 630 that the first object is not referenced in other objects (i.e., the first object is not nested in another object).

Because the first object is not referenced by another object, the object service 212 may then remove 632 the first object from the database 226. Additionally, the object service 212 may update 634 the reference mapping by removing the first object and the reference of the second object. Finally, the object service 212 may communicate 636 a message to the UI 202 informing the user that the first object has been deleted successfully.

Accordingly, the embodiments herein may implement various rules regarding how objects can be created, updated, and deleted. For example, a first object may not reference itself. In other words, “self-nesting” is not allowed. Similarly, cyclic nesting, in which a first object references a second object that references the first object, is not allowed.

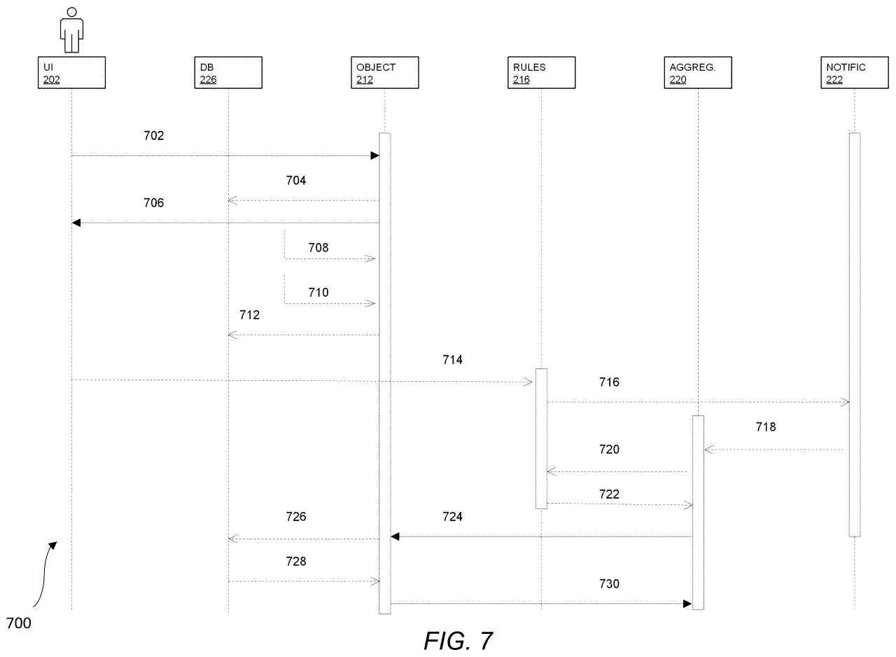

As another example, and as seen in FIG. 7, an object cannot be deleted if it is referenced by another object. That is, a referenced object must be removed from the parent object before the referenced object can be deleted. However, the parent object may be deleted without deleting the child object.

FIG. 7 depicts a sequence diagram 700 of an internal flow for enforcing an object in accordance with one embodiment. This process and in particular the object service 212, is responsible for exposing the internal APIs 302 and 304 of FIG. 3 for retrieving object information in a serialized format, such as a REGO-compatible JSON string. This format is understood by downstream services for subsequent enforcement.

In operation, a user via the UI 206 may create 702 an object API flow, such as to create a first object. The object service 212 may add 704 the first object to the database 226, and communicate 706 a message to the UI 206 informing the user that the object has been created.

The object service 212 may subsequently flatten 708 the object with its nested objects and dedupe the object to remove any duplicate data. The object service 212 may implement any suitable flattening and/or deduping procedures, whether available now or invented hereafter.

The object service 212 may then convert 710 or otherwise serialize the object content into a REGO-compatible JSON string. The object service 212 may then store 712 the flattened object in the database 226. The stored entry may include data such as an object identifier, data regarding the payload of the object, a checksum value (e.g., generated from a Simple Hash Algorithm (SHA-256) value), a timestamp, a date stamp, or the like.

A user may then create 714 a rule API flow by communicating an instruction regarding a desired rule via the UI 206 to the rules service 218. The rules service 218 may send 716 a notification to the notification service 222. The notification may include a Universally Unique Identifier (UUID) of the created, updated, or deleted rule. The notification service 222 may then publish 718 an update regarding the rule to the aggregator service 220. The publication may include various types of data identifying the associated object(s), such as a SHA-256 checksum value, an identifier, a date stamp, a time stamp, or some combination thereof, to ensure the aggregator service 220 fetches all updated objects that are referenced in the rule.

The aggregator service 220 may then fetch 720 the rule from the rules service 218. For example, the aggregator service 220 may issue a request to the rules service 218, wherein the request includes the SHA-256 value or any other type of appropriate identifier. The rules service 218 may then provide 722 a response with the object that is used in the rule.

The aggregator service 220 may then fetch the applicable objects from the object service 212. The aggregator service 220 may issue 724 a GET statement for the required objects based on their UUID, SHA-256 checksum value, or other type of identifier as long as the appropriate objects may be identified.

The object service 212 may then request 726 the flattened object from the database 226, and subsequently receive 728 the requested objects. The object service 212 may then provide 830 the response payload to the aggregator service 220 for enforcement.

The described embodiments prove novel techniques for generating at least one object for a network policy. The disclosed techniques provide technical advantages as they allow policy configurations to be defined in a logical manner. Similarly, the nesting of objects as described herein allows objects to be reused across multiple policies. This preserves computing resources and provides for greater scalability, as administrators do not need to create and store the same rule for multiple objects. This eliminates the need for duplicating common configurations across multiple policies.

According to one aspect, embodiments relate to method for generating at least one object for a network policy. The method includes receiving at an interface a first object including a first plurality of data entries of a first type; storing the first object in a cloud accessible storage location for subsequent access; receiving at the interface a second object including a second plurality of data entries of the first type; storing the second object in the cloud accessible storage location for subsequent access; receiving a request to enforce a network policy that uses the first object; determining, using one or more processors executing instructions stored on memory, that the first object references the second object; and enforcing, using the one or more processors, the network policy using the first object and second object.

In some embodiments, each of the plurality of data entries of the first type relate to an internet protocol (IP) address, a domain address, a file type, a location feature, a protocol, or a port number.

In some embodiments, the method further includes receiving a third object including a third plurality of data entries of the first type, referencing the third object from the second object, and enforcing the network policy further using the third object.

In some embodiments, the method further includes removing the reference of the second object from the first object, wherein the removal of the reference of the second object from the first object removes the second object from the network policy, and enforcing the network policy without using the second object. In some embodiments, the method further includes enforcing a second network policy using the second object.

In some embodiments, the method further includes transforming the first object into a Rego-compatible, JavaScript Object (JSON) notation string ingestible by a policy enforcement module.

In some embodiments, the method further includes performing a validation procedure on the first object and the second object prior to determine the first object and the second object are of the same type prior to enforcing the network policy.

According to another aspect, embodiments relate to a system for generating at least one object for a network policy. The system includes an interface for receiving a first object including a first plurality of data entries of a first type, a second object including a second plurality of data entries of the first type, a network security policy to be enforced, wherein the network security policy uses the first object; one or more cloud accessible storage locations for storing the first object and the second objection; and one or more processors executing instructions stored on memory to determine that the first object references the second object, and enforce the network policy using the first object and the second object.

In some embodiments, each of the plurality of data entries of the first type relate to an internet protocol (IP) address, a domain address, a file type, a location feature, a protocol, or a port number.

In some embodiments, the interface is further configured to receive a third object including a third plurality of data entries of the first type, and the one or more processors are further configured to determine that the second object references the third object, and enforce the network policy further using the third object. In some embodiments, the one or more processors are further configured to enforce a second network policy using the second object.

In some embodiments, the one or more processors are further configured to transform the first object into a Rego-compatible, JavaScript Object (JSON) notation string ingestible by a policy enforcement module.

In some embodiments, the one or more processors are further configured to perform a validation procedure on the first object and the second object to determine the first object and the second object are of the same type prior to enforcing the network policy.

According to another aspect, embodiments relate to a computer program product for generating at least one object for a network policy, the computer program product comprising computer executable code embodied in one or more non-transitory computer readable media that, when executing on one or more processors, performs the steps of receiving at an interface a first object including a first plurality of data entries of a first type, storing the first object in a cloud accessible storage location for subsequent access, receiving at the interface a second object including a second plurality of data entries of the first type, storing the second object in the cloud accessible storage location for subsequent access, receiving a request to enforce a network policy that uses the first object; determining, using one or more processors executing instructions stored on memory, that the first object references the second object; and enforcing, using the one or more processors, the network policy using the first object and second object.

In some embodiments, each of the plurality of data entries of the first type relate to an internet protocol (IP) address, a domain address, a file type, a location feature, a protocol, or a port number.

In some embodiments, the computer program product further includes computer executable code that, when executing on the one or more processors, performs the steps of receiving a third object including a third plurality of data entries of the first type, referencing the third object from the second object, and enforcing the network policy further using the third object.

In some embodiments the computer program product further includes computer executable code that, when executing on the one or more processors, performs the steps of removing the reference of the second object from the first object, wherein the removal of the reference of the second object from the first object removes the second object from the network policy, and removing the reference of the second object from the first object, wherein the removal of the reference of the second object from the first object removes the second object from the network policy.

In some embodiments, the computer program product further includes computer executable code that, when executing on the one or more processors, performs the step of enforcing a second network policy using the second object.

In some embodiments, the computer program product further includes computer executable code that, when executing on the one or more processors, performs the step of transforming the first object into a Rego-compatible, JavaScript Object (JSON) notation string ingestible by a policy enforcement module.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A method for generating at least one object for a network policy, the method comprising:
receiving at an interface a first object including a first plurality of data entries of a first type;
storing the first object in a cloud accessible storage location for subsequent access;
receiving at the interface a second object including a second plurality of data entries of the first type;
storing the second object in the cloud accessible storage location for subsequent access;
receiving a request to enforce a network policy that uses the first object;
determining, using one or more processors executing instructions stored on memory, that the first object references the second object; and
enforcing, using the one or more processors, the network policy using the first object and second object.

2. The method of claim 1 wherein each of the plurality of data entries of the first type relate to an internet protocol (IP) address, a domain address, a file type, a location feature, a protocol, or a port number.

3. The method of claim 1 further comprising:
receiving a third object including a third plurality of data entries of the first type,
referencing the third object from the second object, and
enforcing the network policy further using the third object.

4. The method of claim 1 further comprising:
removing the reference of the second object from the first object, wherein the removal of the reference of the second object from the first object removes the second object from the network policy, and
enforcing the network policy without using the second object.

5. The method of claim 4 further comprising enforcing a second network policy using the second object.

6. The method of claim 1 further comprising transforming the first object into a Rego-compatible, JavaScript Object (JSON) notation string ingestible by a policy enforcement module.

7. The method of claim 1 further comprising performing a validation procedure on the first object and the second object prior to determine the first object and the second object are of the same type prior to enforcing the network policy.

8. A system for generating at least one object for a network policy, the system comprising:
an interface for receiving:
a first object including a first plurality of data entries of a first type,
a second object including a second plurality of data entries of the first type,
a network security policy to be enforced, wherein the network security policy uses the first object;
one or more cloud accessible storage locations for storing the first object and the second object; and
one or more processors executing instructions stored on memory to:
determine that the first object references the second object, and
enforce the network policy using the first object and the second object.

9. The system of claim 8 wherein each of the plurality of data entries of the first type relate to an internet protocol (IP) address, a domain address, a file type, a location feature, a protocol, or a port number.

10. The system of claim 8 wherein the interface is further configured to receive a third object including a third plurality of data entries of the first type, and the one or more processors are further configured to:
determine that the second object reference the third object, and
enforce the network policy further using the third object.

11. The system of claim 8 wherein the one or more processors are further configured to:
remove the reference of the second object from the first object, wherein the removal of the reference of the second object from the first object removes the second object from the network policy, and
enforce the network policy without using the second object.

12. The system of claim 11 wherein the one or more processors are further configured to enforce a second network policy using the second object.

13. The system of claim 12 wherein the one or more processors are further configured to transform the first object into a Rego-compatible, JavaScript Object (JSON) notation string ingestible by a policy enforcement module.

14. The system of claim 12 wherein the one or more processors are further configured to perform a validation procedure on the first object and the second object to determine the first object and the second object are of the same type prior to enforcing the network policy.

15. A computer program product for generating at least one object for a network policy, the computer program product comprising computer executable code embodied in one or more non-transitory computer readable media that, when executing on one or more processors, performs the steps of:
receiving at an interface a first object including a first plurality of data entries of a first type;
storing the first object in a cloud accessible storage location for subsequent access;
receiving at the interface a second object including a second plurality of data entries of the first type;
storing the second object in the cloud accessible storage location for subsequent access;
receiving a request to enforce a network policy that uses the first object;
determining, using one or more processors executing instructions stored on memory, that the first object references the second object; and
enforcing, using the one or more processors, the network policy using the first object and second object.

16. The computer program product of claim 15 wherein each of the plurality of data entries of the first type relate to an internet protocol (IP) address, a domain address, a file type, a location feature, a protocol, or a port number.

17. The computer program product of claim 15 further comprising computer executable code that, when executing on the one or more processors, performs the steps of:
receiving a third object including a third plurality of data entries of the first type,
referencing the third object from the second object, and
enforcing the network policy further using the third object.

18. The computer program product of claim 15 further comprising computer executable code that, when executing on the one or more processors, performs the steps of:
removing the reference of the second object from the first object, wherein the removal of the reference of the second object from the first object removes the second object from the network policy, and
enforcing the network policy without using the second object.

19. The computer program product of claim 15 further comprising computer executable code that, when executing on the one or more processors, enforces a second network policy using the second object.

20. The computer program product of claim 15 further comprising computer executable code that, when executing on the one or more processors, performs the step of transforming the first object into a Rego-compatible, JavaScript Object (JSON) notation string ingestible by a policy enforcement module.
